(19) United States
(12) Patent Application Publication
(10) Pub. No.: US 2018/0129539 A1
(43) Pub. Date: May 10, 2018

(54) Next Gen SDN with Smart Agent Based Routing (SABR)

(71) Applicant: Ali Sadat, Jacana (AU)

(72) Inventor: Ali Sadat, Jacana (AU)

(21) Appl. No.: 15/179,875

(22) Filed: Jun. 10, 2016

Related U.S. Application Data
(60) Provisional application No. 62/254,693, filed on Nov. 12, 2015.
(60) Provisional application No. 62/173,650, filed on Jun. 10, 2015.

(51) Int. Cl. G06F 9/50; G06F 9/54; G06F 9/455; H04L 9/08

(52) U.S. Cl. CPC G06F 9/5061; H04L 9/0825; G06F 9/45558; G06F 9/545

(57) ABSTRACT

A multi-tier solution has been disclosed which in one embodiment provides an easy way to transfer a running application from one device to another. In this embodiment, this innovative approach introduces new multi-tiers application structure which consists of Face, Brain and Body segments, and provides users with different means of application transfer based on their needs.

### BACKGROUND

Throughout this disclosure, the terms virtual machine (VM), container and application are used interchangeably in this entire patent application and mean the same.

The attached 61 figures and the following detailed description illustrate only examples of the present invention. Traditional cloud/share based services require all data to be synced to a device upstream and from there the data will be pushed to other devices. To reduce the necessity of this North-South data traffic pattern, Next Gen SDN enables multiple pieces of hardware and software to reach each other directly independent of their location and means of connectivity to the network. This feature minimizes the need of North-South traffic and optimizes the data traffic using East-West traffic communication. Next Gen SDN, finds the best possible path between hardware and software. SABR adds the “Smart” feature to the Next Gen SDN. While Next Gen SDN finds the best path between devices, SABR creates new paths that could be elected as the Best paths.

### BRIEF DESCRIPTION OF DRAWINGS

FIG. 1 illustrates the overview of NgSDN (Next Gen SDN) infra-structure expanded across multiple areas

FIG. 2 illustrates the overview of use of NgSDN to create connection between 2 devices with WAN assistance,

FIG. 3 illustrates Smart Universal Peripheral diagram and the related traffic path

FIG. 4 illustrates Smart Universal Send-to diagram and the related traffic path

FIG. 5 illustrates Smart Universal File-manager diagram the related traffic path

FIG. 6 illustrates Smart Universal Publish diagram the related traffic path

FIG. 7 illustrates Transfer of Teleporting apps via NgSDN and its traffic path

FIG. 8 illustrates Transfer of Cloning apps via NgSDN and its traffic path

FIG. 9 illustrates the three tier application structure

FIG. 10 illustrates Child and mother application structure and its related traffic path

FIG. 11 illustrates the overview of use of NgSDN to create connection between 2 devices without WAN assistance

FIG. 12 illustrates the overview of CPU authentication diagram

FIG. 13 illustrates the overview of Memory authentication diagram

FIG. 14 illustrates the overview of Network authentication diagram

FIG. 15 illustrates the overview of Storage authentication diagram

FIG. 16 illustrates the overview of Token transfer and its related traffic path

FIG. 17 illustrates the flowchart related to Universal Peripheral Algorithm

FIG. 18 illustrates the flowchart related to Token transfer

FIG. 19 illustrates the flowchart related to Universal Publish Algorithm

FIG. 20 illustrates the flowchart related to CPU Authentication

FIG. 21 illustrates the flowchart related to Memory Authentication

FIG. 22 illustrates the flowchart related to Network Authentication

FIG. 23 illustrates the flowchart related to Storage Authentication

FIG. 24 illustrates the flowchart related to Private Resource Pool

FIG. 25 illustrates the flowchart related to Public Resource Pool

### SABR INITIALIZATION PROCESS

Active Master (AM) is a device that is elected to be a common point of communication for all devices on the same network segment. Election is based on various parameters (e.g. Type of Power, up time, resources, priority, etc).

When a device comes up in a network the Agent on the device tries to detect the location of AM on the location network (these methods are including DHCP data, DNS query, ARP, old cache data). If an AM is detected on the network, the device's Agent will request to join and asks for the most updated network topology and uploads its own info to the AM. AM then updates the new topology to the Cloud and joins the new device to its topology based on Policies.

If AM detection fails, Agent elects itself as AM and tries to contact the cloud to upload the local device data (Location, IP address, Surrounding SSIDs, etc) also it will pull networking topology for other user's devices (IP addresses, Locations, Active Maters and, etc).

In case multiple devices are found in the same environment, an election would take place to select an Active Master and all others will be selected as Candidate Masters (CM). Active Master (AM) is used to optimize communicates, updates, reduce power consumptions and network utilization.

All devices maintain the up-to-date network topology information. This topology would be used to create a routing table between the devices and find the shortest and best paths for transferring data traffic.

Best connection path between devices are detected through different types of connections; including the current local network that devices are connected to, direct access through WAN, through cloud services or establishing a temporary Ad-Hoc wireless connection or any combination of them could be detected as the best path.

If multiple devices of same users get detected on the same network, to optimize the communication and power consumption, a device would be elected as AM and all other will hold CM role. Active master is in charge of presenting most updated network topology to all devices and keep data up to data with any cloud service.

For better security the devices creating modifications on the routing table, can sign their File with Public key and that Signed Routing table will be passed to the Cloud, the cloud has the Private Key and can decrypt the packet and verifies it. Then the cloud will sign the new routing table with Private Key and asks the end devices to download it.

More Info For Next GEN SDN

Common rendezvous point(s) to share or exchange information could be a historical record, predefined, dynamically found location. This location could be included but not limited to Cloud, Upstream, downstream, same area rendezvous point/s or any other types of sharing or exchanging information.

The types of dynamic detections include but not are limited to DHCP, DNS, ARP, Reverse ARP, Net BIOS. The exchanged information, could be the meta data, Data or the Routing table of the Application or Hardware generated the data.

Devices/Applications could directly upload the content to the Common rendezvous point/s or they could send the data/meta-data to the locally elected device/s to upload them to the rendezvous point/s. The data could be transmitted securely or insecurely.

Devices/Application could contact each other directly or indirectly through a 3rd party device/service provider.

SABR intelligence could automatically or manually establish new paths between devices, these devices could be located close or remote from each other.

SABR could be used to connect 2 or more devices that are not connect to each other by any means, an example of these is as follows. Consider that each device being unaware of existence of any possible device around itself. They could have already registered and downloaded some shared info. They also could not have been registered.

Device will sniff all existing Wi-Fi SSIDs, if there is a SSID that its first portion matches preset value, it will check the reset of the SSID and will use the polices to connect it that.

If there is No matching SSID, it will turn its Wi-Fi access-point ON and set the first portion of the SSID Xigrom (as an example) and set the rest of the SSIDs as means of signaling to other devices. Some digits could use to define the Type of Power of the device, registered Account, priority, etc (SSID negotiation).

If there is any device in the area seeing this SSID, and if they have batter suggestion, they can turn ON their Wi-Fi and put a proposal. Devices could use the pre-downloaded password or other means of AAA or none to create a secure or unsecure connection.

Smart Agent Based Routing (SABR)-Hardware Resources

SABR could be used by applications to detect hardware resources available on the platform. It helps them to choose the best hardware available to perform a task (e.g. a mobile application default method of delivering graphics is through network; delivering graphics through network is Not the optimized method but it is very flexible). When an application starts on a platform, it exchanges hardware resources which could be shared and used with Agent on host (Hypervisor). The application initially would use the traditional network method, if Application agent and host Agent reach to an agreement of presenting a hardware resource directly to an application that hardware will be presented to the Application to be used.

Types of Routing Databases

Global Routing Table DB

This routing table is used to route data between multiple users. This routing table could include device routes and locations for all users in the same database. This tablet did not meant to be shared with users and will be stay on the cloud, and only requested results will be forwarded to the users.

User's Routing Table DB

This table contains routes and information about a single user, and would be shared between user's devices and will kept update.

Thumbnail Database

This database contains Universal Toolboxes meta-data and enables agents to locate where the data is and how it could be accessed

Smart Universal Clipboard

This is a solution to share data that is copied or cut from one mobile application/computer to the other mobile application/computer. This innovative approach uses “Agent Based Routing” (ABR) explained previously to avoid north-south traffic transfer to the cloud or a shared storage and instead it uses east-west approach which enables devices only maintain a small content routing table and access the data directly from each other. This approach minimizes power and bandwidth consumption and provides user with most updated data available. Device/Applications should have ABR running and functional.

“Clipboard” Process

When a cut or copy initiated on a device, source computer will create a thumbnail of data and meta-data and sends that to the local AM (if any available) or directly to the cloud (if AM is NOT available). The receiving AM or cloud services would send an update message to all other AMs or CMs to update their thumbnail table.

Thumbnails do not contain the actual data and are only a fraction of them and the holding database is called thumbnail database. The data will reside on the source device and the requesting device would know the source device contact details and will find a direct way to reach it from the ABR table.

The owner of the thumbnail would keep reset the Expire timer to keep it valid, unless it will be erased from all routing tables on all devices.

If Paste is initiated; the requesting device will directly access the source device to pull the information out, if devices could not access each other directly (they might be behind firewall) a cloud service could be used as transiting path; or data to be uploaded temporary storage and gets downloaded by requesting device and gets erased afterwards. (Data does not need to be sent to all devices or sync to them)

Sync to all devices is avoided to reduce the power consumption and BW consumption

If user chooses Static option, data will be uploaded to the Cloud and remain there until user removes it manually, but it will not be Synced to any devices and will only be downloaded by a requesting device.

Smart Universal Send To

This solution enables users to send data to a device or application without need to be present on the other end and data immediately starts to transfer after ‘send to’ is initiated. These data could include Files, Folders, Applications and other types of data. It also enables users to send data outside of their own set of device domains, they can send data to different users or devices. This solution finds the best direct way between 2 devices using Next Gen SDN (NgSDN) and if there is no direct way available might use Cloud services as transit path or temporary cache location. The Data could be sent to the destination device through Agents, or an email or Token could be created and a link to be used for access or download data.

When ‘send to’ is initiated on a device, source computer will identify if device is within current user domain or it is out of current users' domain scope.

If destination/s is within current user domain, device will use the ABR table to find the best path to the destination/s. After checking the related polices it will start the transfer to destination.

If destination/s is NOT within current user domain: device will use the “Nearby Routing Table” and “Global Routing Table” to identify the best path to the destination/s. After checking the related police it will start the transfer.

Smart Universal Publish

This solution provides users an easy way to share data from an Application or Computer to the public. This feature will provide users with an identification number that enables other users to access that data from other devices or from the web.

User selects the data that would like to publish and initiates publish.

The data will get uploaded to the cloud or a common storage and user will be provided with an Identification code.

The data will stay on the common storage based on the policy.

Means of Access

Any user can put that identification code in their applications or devices and the download/access to that data could be initiated. Any user can use the online portal to put in the code and access the data.

Smart Universal File Manager

This solution provides easy means for managing all user's application's and computers' storages as well as dedicated storage devices (e.g. USB, NAS, and Cloud Storage). It enables users to browse storages remotely when they are available or a cached index version of them when they are offline. It enables users to initiate file transfer between 2 devices remotely without needing to be located or logged in to any of them or be as a transit path. It enables users to perform file transfer/delete/modification without any need for devices to be online at the time and the transfer/delete/modification would perform when they become available.

Universal File Manger console could be accesses as a web portal or as an Application on a computer it will benefit from ABR routing table to access all agents on computers or applications.

If a devices is not available and it was chosen to be indexed for offline use, the indexed cached will be presented to the user. If a file/folder modification was requested by user the Agent on the device (or the closest agent) will be instructed to perform the task and report back.

If file/folder transfer requested between 2 devices, the agents of those devices will be informed and the “Agent based Routing” info will be used to find the best path between devices. After finding the best path the agents will start to perform the task and reporting back to the management console. This approach will remove the need of commanding device to be placed in the transit path.

If device are not available, the commands could be cached till they come online and the tasks to be performed.

Smart Universal Peripheral (e.g. Mouse, Keyboard, Audio, Printer)

This solution provides easy means of sharing peripherals connected to one device with other devices independent of their locations based on user's input or physical gestures or instructions (Example of users' gestures include head or eye direction to detect which device user is looking at and dynamically switch the peripheral connection to that device).

This solution benefits from ABR database to find the closest and best path between devices, and will transfer the data (e.g. keystrokes or audios) from Source device to destination.

On Source device that has the peripherals connected, user chooses which peripheral/s will be connected to the destination device. User chooses which device is the destination device for peripheral should be connected to. Agent will use the ABR to find the best path to the destination device. Source agent will negotiate the connection with destination device and a channel will be created. Source agent can collect peripheral inputs (e.g. Keystrokes, audio, etc) and sends/receives them with the destination device.

Multi-Tier Mobile Application/VMs

This multi-tier solution provides an easy way to transfer a running application from one device to another. This innovative approach introduces new multi-tiers application/VM structure which consists of Face, Brain and Body segments, this innovative approach provide users with different means of application transfer based on their needs.

Body

The Body includes 2 main portions. First one is the installed OS (Called the Base OS) binary which is shared between all applications using VM-Linked-Clones concept. This OS could be standardized to be available on all device everywhere, which would remove the need of transferring it while performing the move. The second portion, is the installed application that is isolated from the Base-OS by a Snapshot instance. This enables to run different applications and different instances of the same application on same box. This Snapshot could be standardized to reduce the amount of data required to be sent while transferring an application.

Brain

When application is starting, the RAM and storage changes are getting recorded on RAM and disk, these files/data are called Brain and could be get transferred to different locations based if needed. Brain is the main tier that Application\VM\App\Container\Unikernel or VM does interactions and communicates with hardware modules.

Face

The application display that users interacts with is called Face. The Face will have the ability to connect through network to the Brain which enables the Face to be movable to different device while it is connected to Brain on another device.

This multi-tiers approach enables different ways to mobilize an application between devices and users. Application mobility could be performed between different Computers, cloud computers or any other compatible devices.

Transfer Types

Face Transfer

Face of an application could be independently transferred between computers and keep connectivity to its originating application. The source or destination computer could be a local or a remote device and the move could be initiated by different trigger means. In face only transfer, the Brain and body of the application would remain on the source device and Face only gets transferred while maintaining its connection to its Brain.

Brain Transfer

Brain only transfer migrates the Brain of an application to a computer with compatible Body to Brain to run on it. This transfer will keep the Face of the application on the source PC and Face will maintain the connectivity to the Brain running on remote PC.

Face and Brain Transfer

This type of transfer enables transfer of an entire running application from one device to the other. This type of transfer would require the destination device to have a compatible Body type with the existing running application.

Face, Brain and Body Transfer

This type of application would enable transfer of the entire running application even in case of lack of compatible body on the destination device. This transfer would send across the all body sections if it is required (Body has 2 parts) and Brain and Face to the destination device.

Trigger Types

Transferring different sections of an application could be triggered by different means of Software or Hardware.

Software

A user can initiate the transfer from Cloud or a Management console or it could be initiated from the Source device or be requested from destination device. Also a Token could be used to represent the transfer of the application and be used on the destination device.

Hardware

Hardware triggering also could be used to initiate a transfer, for example in case of shortage of power transfer could be initiated or if 2 device brought down to gather the transfer could be initiated. Other means of hardware trigger could be low power, resource preference, etc.

Teleporting/Cloning Applications

Teleporting application is a new method of transferring application between devices, it enables users to Move an application from one device to the other and the application maintains its status, condition and data on target device the same as the source device. (Based on polices status of the application might change for example private/personal information might be removed) For example, User can select an application and select Teleport and behind the senses the connection will be made to the destination device and the required data are transmit based on the set rules and policies.

Application Cloning enables users to send a copy of the running application from one device to the other. This feature maintains the status of application on destination device (Based on polices status of the application might change for example private/personal information might be removed). Cloned application could be a totally independent instance of the original application or it can replicate what the source application dose, these could be tweaked and tuned using rules and policies.

Wireless Ether-Channel

This innovative solution maximizes the speed of Data transfer between two devices through wireless connections. This approach benefits from sending data through multiple wireless channels at the same time between devices. Use of multiple narrow channels instead of a single wider channel eliminates the possibility of lack of availability of a wide channel at the time.

Two Devices will be triggered to start a channel to each other. Each device will identify how many channels are available to communicate on the frequency ranges allowed; and it will identify what is its Hardware capacity to maintain multiple connections at the time

After initial connection both devices would start to negotiate about the channel that they want to bring up. During negotiate the Number of channels would be decided and how it would be established. Also the Polices would be checked.

After Channel getting established, data transfer will be started. After data transfer based on polices the Tunnel will be tear down or remains up.

Profile Mesh

This innovative approach enables to apply polices to traffic at the source. These profiles contenting polices that need to be applied to traffic and could be cascaded to apply multiple policies at the same time. These polices would applied to traffic prior being sent out to the destination.

Child Application/Console

Child application/console is an extended interface for users to interact with an application. This extended interface could a span off the original application transmitted to or it could be an activated on a secondary device or it could be a script sent to the other device or it could be through a console through a different application (e.g. web based page etc). The originating application called Mother Application and the process of creation is called instance of user's input and presents application output. This Child application could be a VM or an Application. The creation of the Child could be triggered through different software or hardware means (Any means of managing an application on One device from another device is called application birth).

Creation of Child application is triggered by hardware or software. The data required to create the child application would be transferred from Source device to the destination. The Child application will start to run on the secondary device and maintain the connection to the Mother application. Child App starts to perform what it has been assigned to do. Existence of the Child Application will be based on the Set policies or could be terminated by users.

CPU Authentication

Using hardware resource on the cloud is becoming a common trend in the industry and many companies are providing their resources for different customers. Currently there is no means in place to enable to ensure the security of underlying platform. This lack of security enables service providers to sniff the Data transmitted between CPU and Applications. CPU authentication individual VM or applications to securely authenticate before single data transaction to be happen between CPU and Application.

CPU authentication enables VMs or applications or hardware's to securely authenticate to CPU before using CPU resources and sending it instructions. The authentication could be perform before, during or after VM or application come online. This authentication could be perform as a log in check between CPU and other party, or as Instruction and data encryption between the CPU or other party or a combination of these.

VM/Application will start to negotiate with Hypervisor OR directly with hardware. VM/Application would negotiate the Security parameters with each other and each side would verify the validity of the other party either locally or through a remote system. After successful authentication, if it is required, type of encryption for data traffic would be negotiated. Then connection will be established.

Memory Authentication

Memory authentication enables VMs or applications or hardware's to securely authenticate to Memory before using Memory resources and sending it data. The authentication could be perform before, during or after VM or application come online. This authentication could be perform as a log in check between Memory and other party, or as data encryption between the Memory or other party or a combination of these.

VM/Application will start to negotiate with Hypervisor OR directly with hardware. VM/Application would negotiate the Security parameters with each other and each side would verify the validity of the other party either locally or through a remote system. After successful authentication, if it is required, type of encryption for data traffic would be negotiated. Then connection will be established.

Network-Card Authentication

Network authentication enables VMs or applications or hardware's to securely authenticate to networking providing resource before sending any data packets across. The authentication could be perform before, during or after VM or application come online. This authentication could be perform as a log in check between network-Card and other party.

VM/Application will start to negotiate with Hypervisor OR directly with hardware. VM/Application would negotiate the Security parameters with each other and each side would verify the validity of the other party either locally or through a remote system. After successful authentication, if it is required, type of encryption for data traffic would be negotiated. Use of the resource will be started.

Storage-Controller Authentication

Storage-Controller authentication enables VMs or applications or hardware's to securely authenticate to Storage providing resource before sending any data packets across. The authentication could be perform before, during or after VM or application come online. This authentication could be perform as a log in check between Storage-Controller and other party.

VM/Application will start to negotiate with Hypervisor OR directly with hardware. VM/Application would negotiate the Security parameters with each other and each side would verify the validity of the other party either locally or through a remote system. After successful authentication, if it is required, type of encryption for data traffic would be negotiated. Use of the resource will be started.

Token Transfer

Token transfer enables users to transfer files and application without need of immediate transfer. A Token is a small descriptive file that contains where a file or application is, and how it could be accessed and the transfer could be initiated. Token could be created on Source device, Management console or any other authorized 3rd party device. The Token size is a fraction of data, and could be transferred to any compatible destination, the destination using the Data in the token transfer of the Data could be initiated.

Token Creation

Token creation is initiated by application or user. Based on polices token will get created containing File/Application location, Username/Password and Token gets stored on a storage or sent through an email.

Token Usage

The token is opened on a Destination device, the data inside the token is used to access the source data/application, the required task will be initiated.

XigApp Compiler

This complier accept and installable file as an input. User will select the type of the OS the application is designed for. The compiler uses standard Base Body to get the application installed on with the required user settings. The output of the complier will be the second portion of the body that could be distributed to any device.

Self-destruct (Child, VM, File)

This feature enables a data to be erased without any user interaction on a Live device or when it becomes available. This command could be triggered by an application itself or through a remote or local console. When a Hypervisor/Software/Hardware detects this trigger it deletes the data it is instructed delete. If a File/VM/XigApp or an application detects this trigger it will initiate deletion of data it is instructed.

Self-destruction file version 1 is made of a variation of emulated Hard-disk files (like vmdk, vhd), that are containing the file and related policies. For been activated it has be mounted to a Storage solution/Hypervisor or an application, then the policies would be used to provide required permissions. The policies could contain self-destruct, Permission polices or Sync-polices between the Active file and other Peers or Central server.

Smart Files (File VM)

Traditionally files are passive objects and wait for an Application to be open up with, then the security matters will be checked and polices to be applied. Smart Files, maintain a constant connection to their originating source and receive updates or apply polices if it is required. These files also maintain an update to the management connection about their location and other information if it is required.

Smart Files could be an entire VM or a VHD file that could be connected to the hosting Hypervisor and appear as a Storage. First partition of the VHD would be polices and . . . and the Second partition would be the actual data itself.

Based on the user subscriptions, the meta-data of the file versioning (Or even the file itself) could be kept on the cloud and in case all other peer files are not reachable.

Unified Hypervisors

It is a highly optimized Hypervisor that has the ability of running on multiple user or Businesses devices. This innovative product maximizes user mobility and devices performance and functionality. It creates a unified platform across all users' devices and servicing Datacenter to facilitate the application migration and etc. Users' devices could including Wearable devices like Watch or glasses or Mobile devices like Mobile/Table/Laptop or Desktops. These device could be running the common Application or XigApps. The migration of Applications between devices could be trigger manually or automatically based on the configured policy.

Private Resource Pool

This innovative solution that enables users to combine the computing, networking, and/or peripheral power of multiple devices available to the user. Users can distribute their workload between these devices or they could use interfaces provided by other devices like Tablets, Phones and etc. to provide better interaction with original application. The agent installed on each device would report to the management portal the existing resources used or available resources. Users can configure devices to be in the same pool or different pools. The process of Load distribution between different devices could be automated or manual.

The creation of CPU/Memory/Storage/networking and other computing resources could be called Resource pool/team and sharing multiple devices peripherals could be called Peripheral Sharing.

Public Resource Pool

This innovative solution enables users to use the resources provided by servicing datacenters to facilitate their computing needs. It enables users to push (Teleport/Clone) their application to datacenters to use the resources provided.

Hybrid Resource Pool

Hybrid resource pool is a combination of the “Private Resource Pool” and “Public Resource Pool”. It enables users to benefit from resources provided by multiple resources and distribute their work load between their local private devices and the public available. The distribution of load between resource could be performed manually or by an automate process.

Smart-Trigger

This new feature uses physical means to create a trigger signal to the internal processors of a computing device. One of the examples for this trigger is a combination of Magnetic-switches and Magnets (or any other switches for that purpose) on the devices to create a trigger, when a device is closed to another device, each device magnet triggers the other device Switch, and this creates a trigger in the software. The software based algorithm could use the trigger to start other tasks.

Xig-Card

To manage application mobility for cases sites has become unreachable or the site has not been configured, there is a need for a reliable and stable connection. This connection could be used as back door or backup connection. Xig-Card is a module having stable network connection through 3G/4G or other types of WAN connections. It enables users to have access to the required sites or devices and creates an independent management network that could be used to configure systems or transited data.

Rules and Policies

The console provided for users enables them to set Rule and policies to manage Applications, Devices and Files on any devices they choose. These rules and policies could use the GPS/IP location, Wireless Location Services, Hardware information and other means of information to detect a condition and apply rules.

Cloud PC

Cloud PC is a virtual computing device created from different components of different devices, these resources could be gathered from different devices to form one virtual device. For example, multiple device could share keyboard, speaker, microphone, CPU, Memory, etc and bind all of these together to create a virtual computing device.

Multi Stage and Auto Revert Configuration Commit

This method enables central servers to push out candidate configuration to all devices they can, and for preventing the device to loss of access to the central site, they after receiving the new config, will check some defined check and in case of failure they will revert back to the previous config.

Linked Apps

Linked App is multiple copies of the same application running on multiple devices at the same time. These instances are synced with each other and present the same content to the user or connected hardware. One or more instance of the application can be the leader and other instances are followers. Follower instances can choose which Leader they can sync to. Leader instances can choose which instances they can lead. Synchronization of instances could be forced manually or could be performed automatically. Users with follower instances could take control of their instances and do not follow the leader instance anymore, for example when a user touches the screen of their device that instance would detect that and gets out of sync.

Multi Face Applications

Multi face application is referred to an active application running on a device, which has multiple point of user interaction and data entry points. The interfaces could be created by child applications or other type of applications like a web-interface. These interactive points enable users to have a large screen interface to work with and interact with the mother application.

Application Pouring

Application pouring is for making Application Teleporting feature easier for users. The pouring feature uses combination of App teleport or cloning with location detection feature on devices. When user bring 2 device together a connection is established between them and instead of transferring application by touching, the titles of devices are detected and all applications will be transferred to the other device.

Smart Universal Peripheral Face Direction Detection

This feature uses cameras or other types of peripherals and input devices to detect the direction user head direction or eye movement and directs the Peripheral connectivity to that computing device. This process could be performed automatically or manually and preset polices could be applied.

Smartwatch Transfer

This is a way to transfer live, suspended or a portion of an application, file, and container, VM or smart-file between devices using Smartwatch, a form of storage or other devices. This type of transfer is triggered locally or from the cloud, NFC or magnetic triggers or any other trigger types.

Smart-Watch—Token

Tokens contain the address where an application/container/file/smart/file or VM locates. From the source device or any local or cloud based management console, tokens are transferred to destination using smartwatch, storage devices or sent across using other means of communications such as email or chat. On destination side, these tokens are used to access or transfer the application/container/VM/File or Smart-file to the destination device.

Smart-Watch—Full Transfer

In this type of transfer the entire VM\App\Container\Unikernel/App/VM/File or Smart-file is transferred to a smartwatch or a storage and be transferred to the destination. During the transfer, the application could be live or suspended. On the destination, the container/app/VM/file or Smart-file could be transferred from smart-watch or storage device to the destination device.

Smartwatch—Partial

To minimize the amount of data transfer to smart-watch or storage. The transferred data could be limited to a portion of VM\App\Container\Unikernel/App/VM/File or Smart-file; this small data could be sent to a Smartwatch or storage device and on the destination sent to the destination device. During the transfer the data could be Live or suspended.

Data Finger Printing

To avoid excessive data transmission for App/VM/VM\App\Container\Unikernel/File and Smart-file teleportation and cloning, the body or any additional data link to them is standardized across all devices and a fingerprint of them could be created. The destination device can detect and the carrying device can vary this finger print data required to run the application. If this data is missing on the destination device, it could be downloaded or transferred for instance from a cloud or source device. This fingerprint is used in conjunction of data deduplication to reduce the data stored on device and data needed to be transferred.

Application Pouring

In one embodiment, application (app) pouring is for making application teleporting feature easier for users. The pouring feature uses combination of app teleport or cloning with location detection feature on devices. When user brings the two devices together, a connection is established between them and Application/VM\App\Container\Unikernel/File/Smart-file data transfer could be initiate by tilt, other gestures of any of the devices, or any other sort of commands; and all or a specific number of applications will be transferred to the other device.

User/Company Domains

Application teleportation and cloning introduce new security challenges related to personal privacy and corporate security. Users can teleport and clone licensed applications, personal and business sensitive data to anyone, anywhere at any time. These are new challenges, and cannot be answered by existing traditional security systems and requires a new way of thinking.

We have introduced new revolutionary concept of User/Company Domains to answer these new increasing security demands. These virtualized borderless domains enable Users and IT Administrator to monitor and manage their Applications, Devices and Smart-Files activities within or at the boundaries of these domains. These domains contain all users or businesses App/File/Smart-file/VM\App\Container\Unikernel or VMs as objects, which could be controlled or managed remotely or locally. They can set Rules and Policies from Management console on the cloud or their devices to control their Security and Data Privacy.

These domains can overlap, share the same objects with multiple domains. Objects can belong to different domains and can co-exist with each other. All these could be controlled and managed by users and administrator and required rules and policies could be set.

Application Ownership

All objects introduced in User/Company-domain can have one or multiple owners, and this ownership can be managed or inherited through a tree structure to other users, companies or objects. These ownerships remain the same after teleportation or cloning; unless otherwise has been configured by user, rule, polices or default settings. Users can control the objects they own from their devices or a cloud service. Users can transfer the ownership of these objects or ask to take ownership of an object.

Plug and Play Profiles

User profiles could be cloned or teleported by Applications/VM\App\Container\Unikernels/VMs/Smart files and Files Teleportation or Cloning. Plug and Play profiles enable users to extract their Profiles (Unplug) from Applications/VM\App\Container\Unikernels/VMs/Smart files and Files, and instead someone else's profile be inserted to these objects (Plug). This process could happen through different means including user attempt to transfer ownership/rules and polices/admin request or an automated process. These types of profiles are designed to keep applications running and stable and in some cases they need applications to be restarted or paused.

License Types

Teleporting and cloning of application/file/smart-file and VM require new types of licensing. We introduced new licensing types including the following.

On-demand-licenses—in one embodiment, this type of license is issued at the start/Middle or end of Teleportation or Cloning process and their validity time and features could vary based on rules and policies defined.

Hop based Licenses—The licenses have a time to live and can be replicated, each replication reduces their time to live and after hitting the defined number of hops these licenses get expired.

User/Company-Domain based licenses—The licenses are valid over all or a portion of a User/Company domain. Depending on the set rules and polices, these license borders could be limited or expanded.

To manage and monitor all applications/VM\App\Container\Unikernels/VMs/File and smart-files licensing from one console, a local or cloud based monitoring and management solution can be used.

Unified Hypervisors (VM\App\Container\Unikernel Visor)

It is a highly optimized Hypervisor that has the ability of running on multiple devices and provide the similar computing platform on multiple devices. This hypervisor can run one or multiple VM\App\Container\Unikernel hypervisors on its top. This enables users to access different containers types running on different types of container hypervisors. Users can migrate VM\App\Container\Unikernel-hypervisors or their VM\App\Container\Unikernels between devices, if a container migration is initiated and the compatible container-hypervisor is not running on the target device, through a manual or automated process the related container-hypervisor could be started.

Smart Universal Send to/Universal Send to/Dialer Transfer

This is a way to send applications/VM\App\Container\Unikernels/VMs/File and smart-files to a user or a device by dialing their phone number or a given ID. When this type of transfer been requested, the data or content needed will be sent across to the destination device. Dialer transfer could be used to send any of the introduced tiers (Body, Brain and Face) individually or any combination of them together.

Multi-tier Mobile Application/XigApp

This multi-tier solution provides an easy way to transfer a running application from one device to another. This innovative approach introduces new multi-tiers application structure which consists of Face, Brain and Body segments, this innovative approach provide users with different means of application transfer based on their needs. This could be based on VM or VM\App\Container\Unikernels.

Body—It is the part of VM/VM\App\Container\Unikernel/Smart-File that holds the main portion of data and files for running the application. The part could be standardized and finger printed. Finger printing of the Body means it will be the same across entire all devices. In case a device needs to download the body to run an application, it can download it from the cloud or from other devices. The body could include updates or modification as snapshots and they all could be finger-printed to be standard across all devices. Body used be used in conjunction of data deduplication to reduce amount of required data to transfer.

Brain—It is the active part of VM/VM\App\Container\Unikernel/Smart-File, it could be transferred or copied to other device for data processing or Application/VM\App\Container\Unikernel Cloning or Teleportation. It could be suspended and saved to a disk and transferred; it could be copied to other devices through direct network transfer or storage.

Face—The application display that users interacts with is called Face. Face has the ability to connect to Brain locally or remotely.

Transfer Types

Face transfer —Face of an application/container or VM could be independently transferred between devices and maintain connection to its original brain. The source or destination devices could be local or remote devices. In face only transfer, the Brain and body of the application would remain on the source device and Face only gets transferred while maintaining its connection to its Brain.

Brain transfer—Brain only transfer migrates the Brain of an Application/VM\App\Container\Unikernel or VM to a computer with compatible Body to Brain to run on it. This transfer will keep the Face of the application/VM\App\Container\Unikernel/VM on the source computer and Face will maintain the connectivity to the Brain running on remote source computer.

Face and Brain Transfer—This type of transfer enables transfer of an entire running Application/VM\App\Container\Unikernel or VM from one device to the other. This type of transfer would require the destination device to have a compatible Body.

Face, Brain and Body Transfer—This type transfer enables transfer of the entire running Application/VM\App\Container\Unikernel or VM even if the body does not exist on the destination device. This transfer sends everything required from source to the destination.

Teleporting/Cloning Applications—Teleporting application is a new method of transferring Application/VM\App\Container\Unikernel/VM between mobile and any other devices. It enables users to Move an Application/VM\App\Container\Unikernel/VM from one device to the other and the without changing its status, condition and data. (Based on polices status of the application might change for example private/personal information might be removed) For example, User can select an application and select Teleport and behind the senses the connection will be made to the destination device and the required data are transmit based on the set rules and policies.

Application Cloning enables users to send a copy of the running Application, VM\App\Container\Unikernel, or VM from one device to the other while maintaining its status during the transfer (Based on polices status of the application might change for example private/personal information might be removed). There are two types of clones: independent clones or synced clones. Independent clones run totally independent from the original instance. Synced Clones can run independent from the original instance and could be forced to sync to the status of the original instance. This forced sync could be user based, automatic or rule- and/or policy-based.

Teleportation and Cloning could be performed by sending across the entire App/VM\App\Container\Unikernel/VM, or the amount of data transfer could be limited to a small portion of data from the source device. If there is any missing data on the destination device, it could be downloaded from cloud or other devices.

Teleportation and cloning could be triggered by user from devices console, cloud portal or devices touch. Devices touch could be detected through different means including magnetic trigger, NFC or other means of wired or wireless triggers.

Application Teleportation and Cloning for businesses could be managed and monitored from an on premises or off site system. This system could collect and manage all data related to Teleportation and Cloning and other related services.

Child Application/Console/VM\App\Container\Unikernel

Child application/console/containers is an extended interface for users which could be a script or small application/console/containers inside or aside the mother application/container/VM. The creation of the Child could be triggered through different software or hardware means and any means of managing an application on one device from another device is herein called application birth.

Creation of Child application/container is triggered by hardware or software.

The data required to create the child application/container would be transferred from Source device to the destination.

The Child application/container will start to run on the secondary device and maintain the connection to the Mother Application/container.

Child App starts to perform what it has been assigned to do.

Existence of the Child Application/container will be based on the Set policies or could be terminated by users.

Self-destruct (Child, VM, File, VM\App\Container\Unikernel)

This feature enables data to be erased on a live device or when it becomes available, without any need for user interaction. This command could be triggered by an application itself or through a remote or local console. When a Hypervisor/Software/Hardware detects this trigger it deletes the data it is instructed to delete. If a File/VM/XigApp/container or an application detects this trigger it will initiate deletion of data it is instructed.

Smart Files

Traditionally files are passive objects and wait for an Application to be opened up with. Subsequently, the security matters will be checked and polices are applied. Smart Files, however, maintain a constant connection to their originating source and receive updates or apply polices if required. These files also maintain an update to the management connection about their location and other information if required.

Smart Files use file virtualization technology and monitor the accessing application behavior and if they teleported or cloned, they will teleport or clone themselves with them. This could be triggered manually, automatically or by rule and policies.

Smart files could monitor applications/container/VM/ . . . to take the appropriate actions. Smart-files can keep the track of file content changes with revert option to older versions. Smart-files can sync the content to a centralized server or to other Smart-files. Smart-files can encrypt their content. Smart-files' content can be locked and erased locally or remotely. Smart-files number of copies could be managed and be limited, and further copies to be stopped. Smart-files could be Teleported and Cloned with teleporting and cloning VM/App/File/Smart-file. Rules and Policies could be applied to Smart-files or their content and behavior management

Enterprise Application Teleportation Manager (EATM):

EATM is a Cloud or an on premises solution to provide Businesses and individual to monitor and manage application Teleportation and Cloning on their devices on-site or off-site. EATM could be a single or a combination of appliances on site or on the cloud. It monitors all devices, applications and user with the defined boundaries defined by users or IT admins and provides an easy to navigate console for users and admins to manage all devices, application and users.

### EXAMPLE APPLICATIONS

1. Providing easy graphical interface for transferring applications and files between devices.

2. Proximity detection of devices and creating dynamic\static connection between them.

3. Transfer and sharing of Applications, VMs\VM\App\Container\Unikernels and data between multiple devices.

4. Providing application license management tool.

5. Providing integration tools with other 3rd party applications and equipment.

6. To provide means user interface for application VM\App\Container\Unikernel transfer between devices, users can place applications in a place holder presented on the screen and take the app out of the sample place holder on their destination devices.

7. New interfaces been developed as show in the diagram to present place holders on multiple devices. By place application to place holder show on the screen the application become available on other devices having access to the placeholder targeted devices. The other interface provided for transfer is an icon shown on the application screen. Users will be presented with the list of tasks they can perform on the application and list of devices they can send their application VM\App\Container\Unikernel too.

8. To provide contact less wireless authentication with minimizing amount of data transferred between devices a new SSID authentication mechanism has been introduced. The SSID device broadcasts will contain necessary data to illustrate the receiver of broadcast how to create a communication channel between to the broadcasting device. This broadcasted details could include clear text or encrypted data about, username, password, system details and other mandatory or optional details.

9. To provide easy interface for application VM\App\Container\Unikernel\transfer between devices, new shortcuts been developed. Touch of multiple fingers or combination of keys could be used as a shortcut for faster transfer, for example use of 3 fingers could be used as shortcut for teleport and 4 fingers for clone.

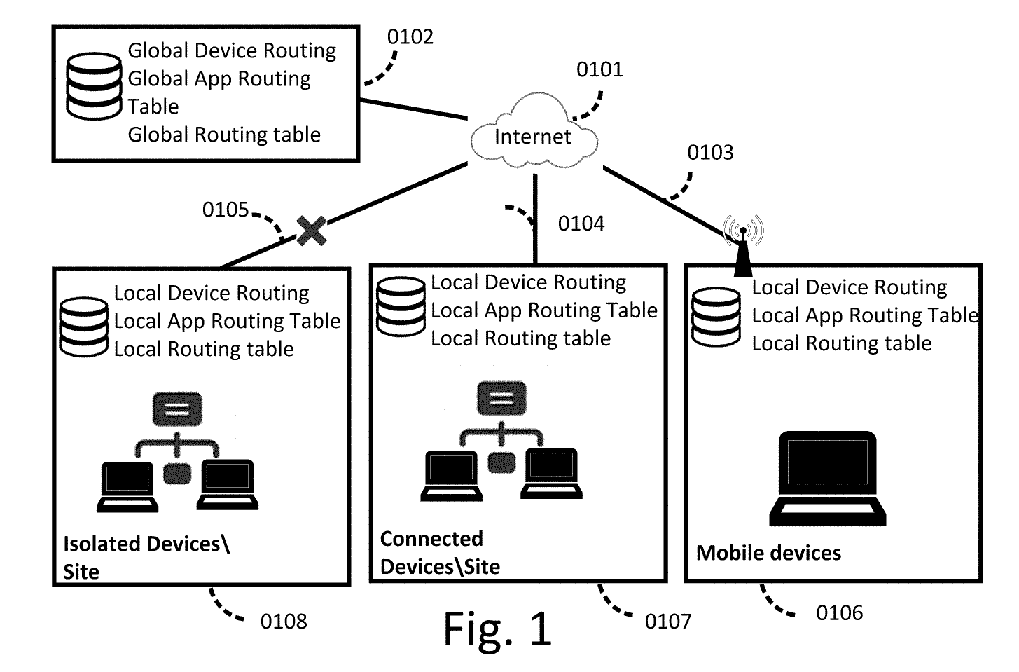

In FIG. 1, 0100 diagram illustrates the overview of NgSDN technology and how it could provide connectivity between multiple devices with or without a common connection point. Item 0101 illustrates a common network between different devices and areas NgSDN has been used, 0102 illustrates a common point of contact which acts as global repository of the enter NgSDN topology. 0103, 0104 are provided connection between different areas to the common point in the NgSDN env. 0105 shows an area that has been disconnected from the rest of NgSDN env and works as an isolated env. 0106 illustrates a mobile device as an independent area connected to the NgSDn env using a wireless link, this area holds its own Local routing data bases and share those with the common point on the network. 0107 shows a local area containing multiple devices which create a unified local data base and share that via network connection to the cloud. 0108 shows an isolated areas that is disconnected from the rest of NgSDN and maintains a local routing table for local connection between devices without any means for sharing with the common point on the cloud.

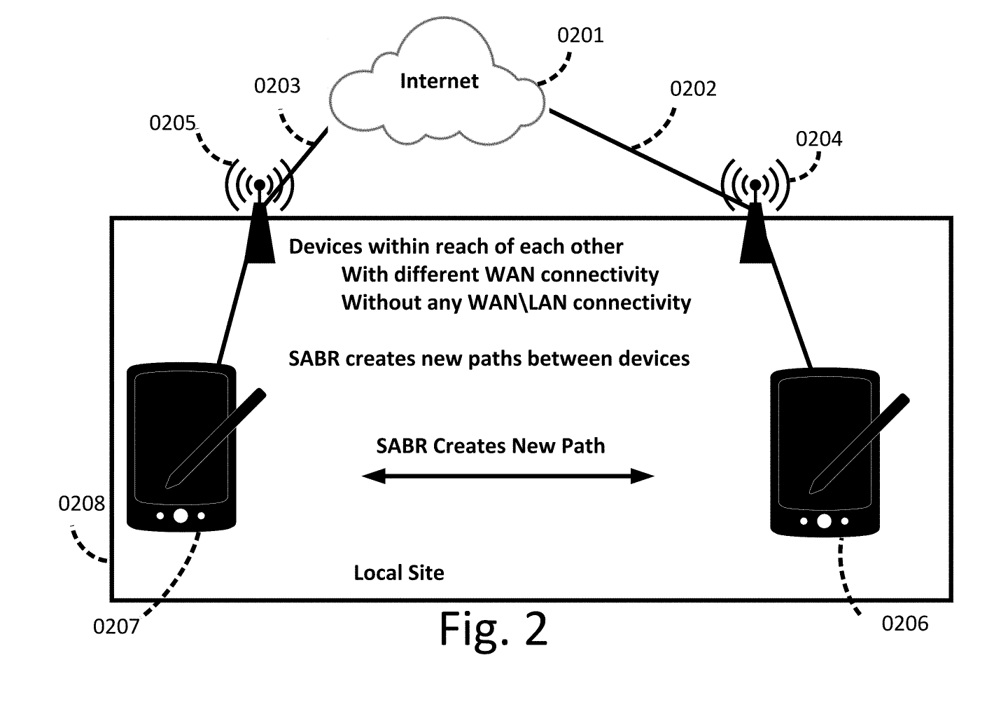

In FIG. 2, 0200 diagram illustrates how 2 devices can use a common network connection to create a direct connection with each other. 0201 shows a common point of contact or network which device could obtain the data of how to reach the other device directly by means enabling their Wifi or act as a hotspot with a specific SSID for other device to connect to. 0202, 0203, 0204, 0205 show different means of connections these device could use to reach the common point on the cloud. 0206, 0207 represent the devices attempting to create direct connection with each other. 0208 illustrates the approximately of the device and shows these 2 devices can reach each other via a common network or wireless connection.

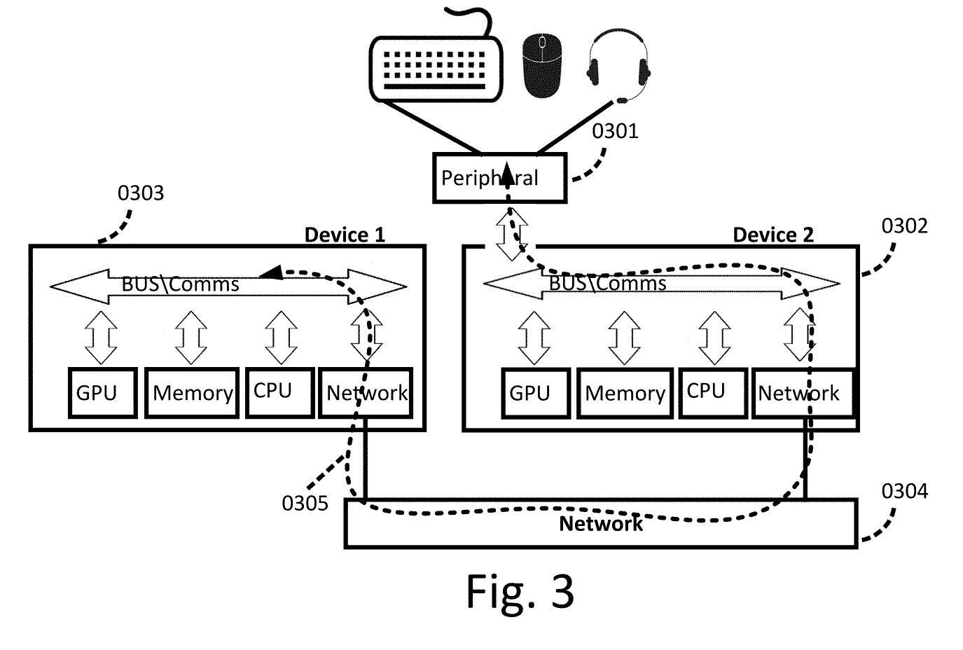

In FIG. 3, 0300 diagram presents how peripheral devices from one device could be presented and access to a second device. 0301 illustrates a set of peripheral device connected to device 2 and presented to device 1 via different connections between two devices. 0302 illustrates computing device 2 with some of it internal components and peripheral connected to it. 0303 illustrates computing device 1 which peripherals of device 2 are presented to it and made available to different hardware and software running on device 1. 0304 presents a connection medium between 2 computing devices which could include different types of networks including but not limited to WAN\MAN\LAN\PAN\Wired and Wireless networks. 0305 illustrates the traffic path of how these peripheral are presented to device 1 and commination between these peripherals and accessing hardware and software.

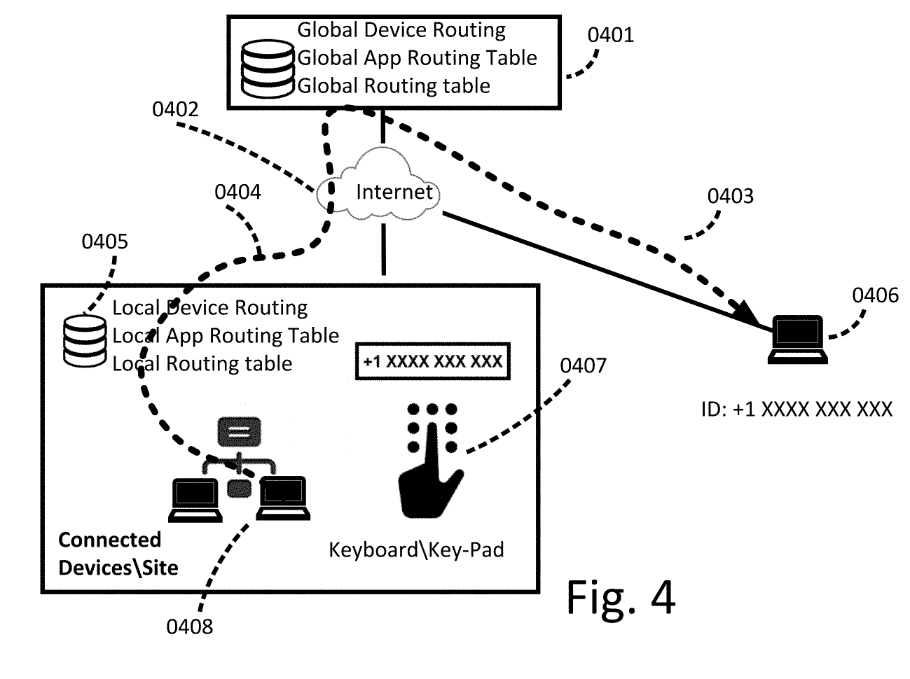

In FIG. 4, 0400 diagram presents how Universal Send-to feature works and how contents could be sent to a remote device. 0401 illustrate a share location that could be used as the transit path if the remote device is not directly available for the source device. 0402 illustrates means of connectivity to the stated traffic transit point which could be WAN\MAN\LAN\PAN\Wired or Wireless network. 0403 illustrates the data traffic after been directed to the destination device via transit point. 0404 illustrate traffic generated by source devices going towards the transit point to be directed to the destination device. 0405 illustrates the local repository that is been used to store local routing table and details of how to reach transit location or remote device. 0406 illustrates the remote device with its unique identification number which is acting as the destination of sent traffic. 0407 illustrates user putting the unique number of the destination device for file\data transfer to begin. 0408 illustrates the device holding the original data which initiates the send-to traffic.

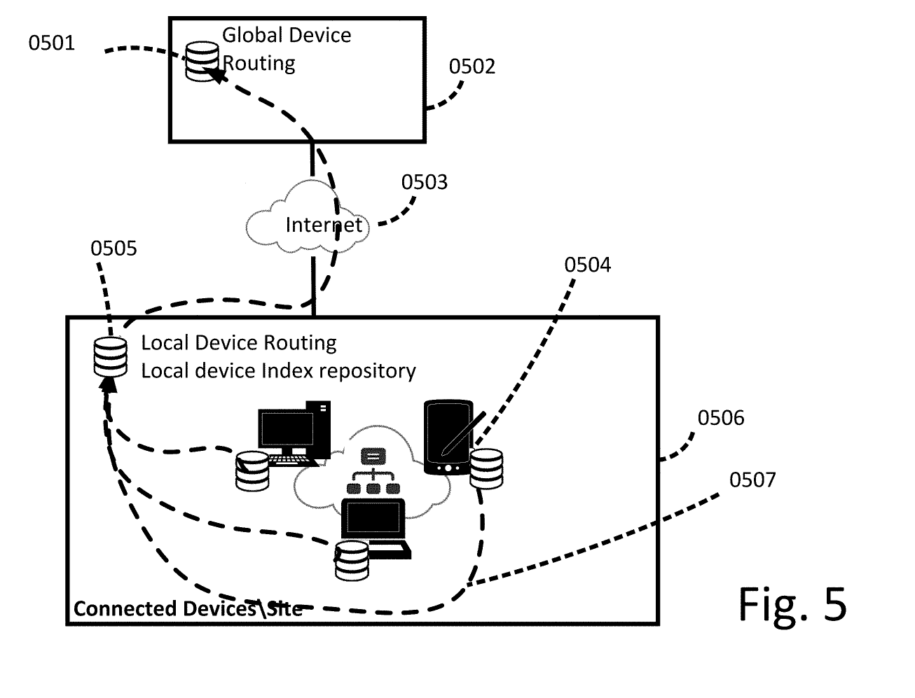

In FIG. 5, 0500 diagram presents how Universal File-Manger feature works and how every device could observe what files other devices are holding. 0501 illustrate a central location on a remote site that holding all data and Meta data uploaded by all other devices. 0502 illustrates the remote site connected to all other user's devices and sites. 0503 illustrates the means of connectivity between user's different devices and sites which could include WAN\MAN\LAN\PAN\Wired or Wireless networks. 0504 illustrates different user devices collecting data a Meta data of the files available on their device storage. 0505 illustrates a local site repository that devices would upload their data and Meta data of their files for other local devices faster access and less consumption of bandwidth. 0506 represents the boundary of devices located in the same area. 0507 illustrate devices traffic path for uploading\downloading their data and Meta data to the local common repository for other devices access.

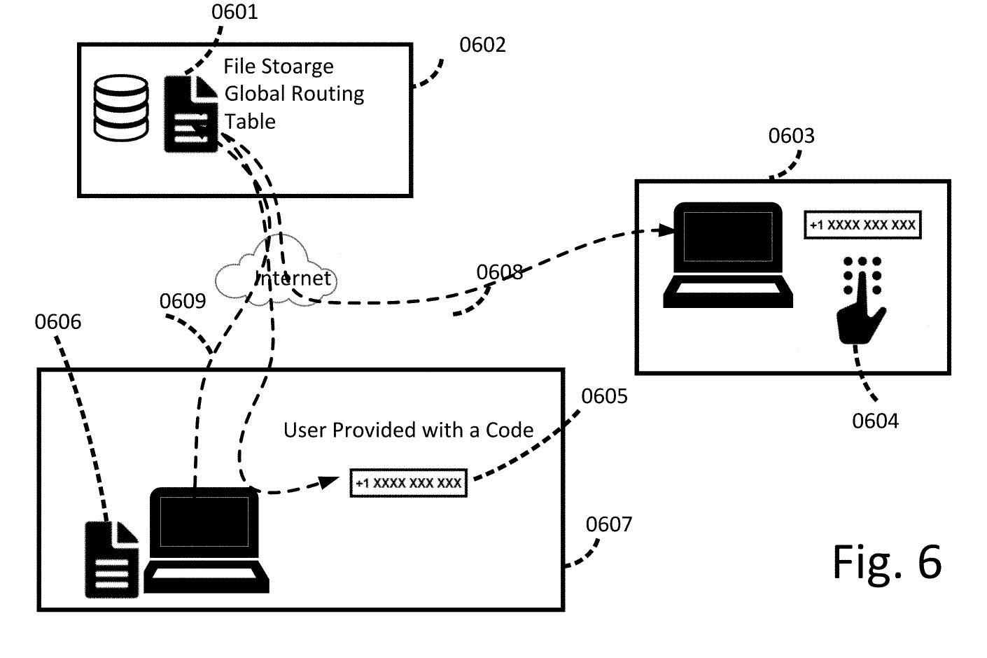

In FIG. 6, 0600 diagram presents how Smart Universal Publish feature works and how uploaded data or Meta data are made available to the remote devices. 0601 illustrates the uploaded data or Meta data by the source device. 0602 illustrates a share storage location that could be access by all remote users and devices. 0603 illustrates a remotely located user or device trying to access the uploaded data or Meta-data. 0604 illustrates the unique code associated to the uploaded data\meta data has been entered to access the data. 0605 illustrates the unique code generated by the remote storage for the uploaded data and was provided to the user. 0606 illustrates the file that itself or its Meta data is getting uploaded to the cloud to become remotely accessible. 0607 illustrates the location of the source device trying to upload the data to the cloud. 0608 illustrates the traffic path of device receiving the uploaded data or Meta data to the cloud. 0609 illustrates the traffic path of the source device uploading the data or\and its Meta data to the common point of access by remote devices.

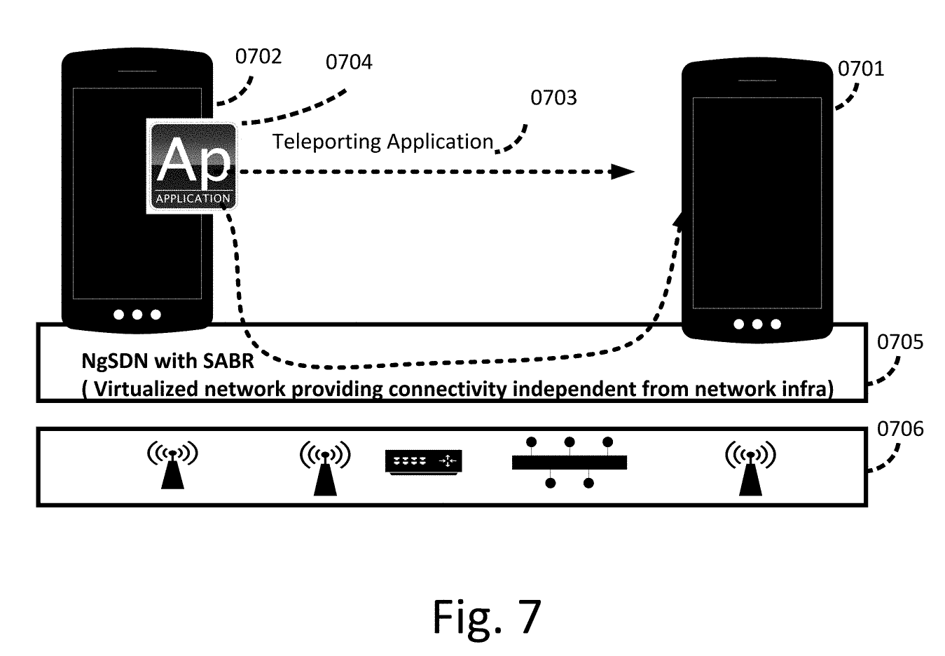

In FIG. 7, 0700 diagram presents how application teleportation would be performed using NgSDN or other means of connectivity. 0701 shows the destination device receiving the Teleporting application from the source device. 0702 shows the source device currently hosting the running applications that been tried to be teleported to the other device. 0703 show the direction the application been teleported and moved across from the source device to the destination device. The stated application could be a VM\Container\Unikernel or a combination of each or all. 0704 illustrates the running application on the source device that been attempted to be teleported across to the second computing device. 0705 illustrates the means of connectivity between 2 devices which could be provided via NgSDN or any other means of network connectivity. 0706 is the underlay network infrastructure which provide L2 and L1 network connectivity means for data to be transferred, this layer is transparent from the application prospective.

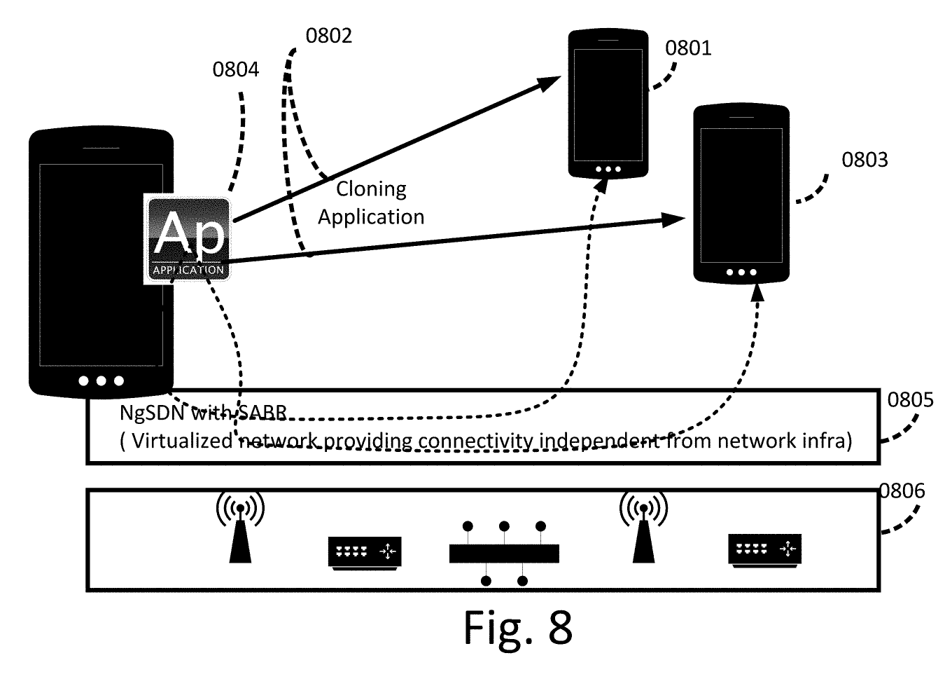

In FIG. 8, 0800 diagram presents how application cloning would be performed using NgSDN or other mean of data connectivity. 0801 and 0803 are destination devices will be receiving the Clone version of the application running on the source device, these application could maintain a sync status after they are transferred or they could run independently from the original copy of the application. 0804 illustrates the original version of the running application residing on the source device. 0805 illustrates the NgSDN or other means of data connectivity for data to be transferred between devices. 0806 illustrates the L1 and L2 network connectivity means which will be transparent from application getting cloned to the other devices point of view.

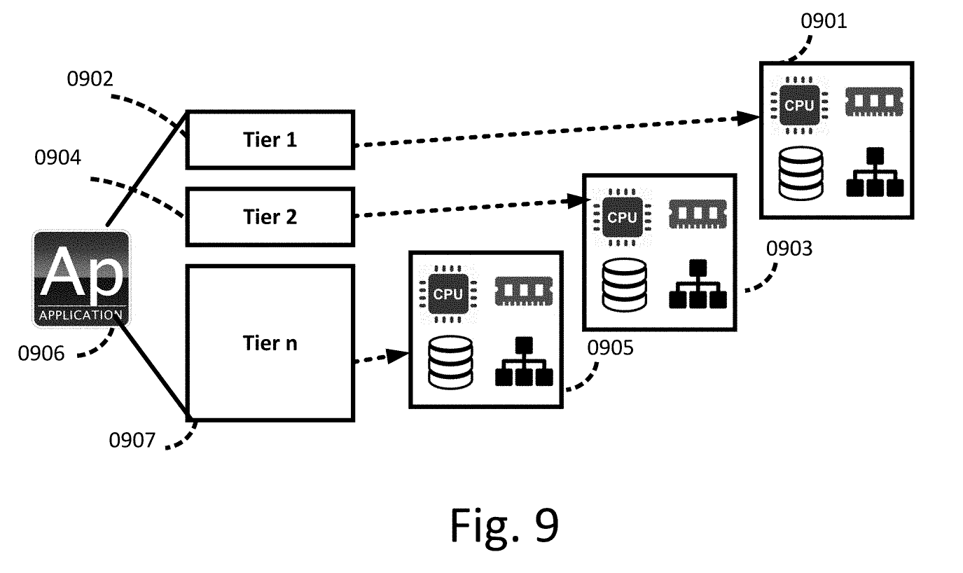

In FIG. 9, 0900 diagram presents the structure of multi-tier application. 0906 illustrates the multi-tier application which is consist of 3 main parting including Face, Brain and Body of the application. 0902 illustrates the face of the application which is the section that is presented to user via a peripheral for user interaction. 0901 illustrates the resource the face can use which could include but not limited to computing\memory\network and storage resources. The face of the application is contact with the brain of the application using direct mapping, X-Server, RDP and other means of connectivity. 0904 illustrates the Brain of the application which acts as the active part of the application and 0903 illustrates the resource the brain can use to perform these tasks, these resources are including but not limited to computing\memory\network and storage resources. 0907 illustrates the body of the application which contains the main portion of application data files and as 0905 illustrates it can use different resource including but not limited to computing\memory\network and storage resources.

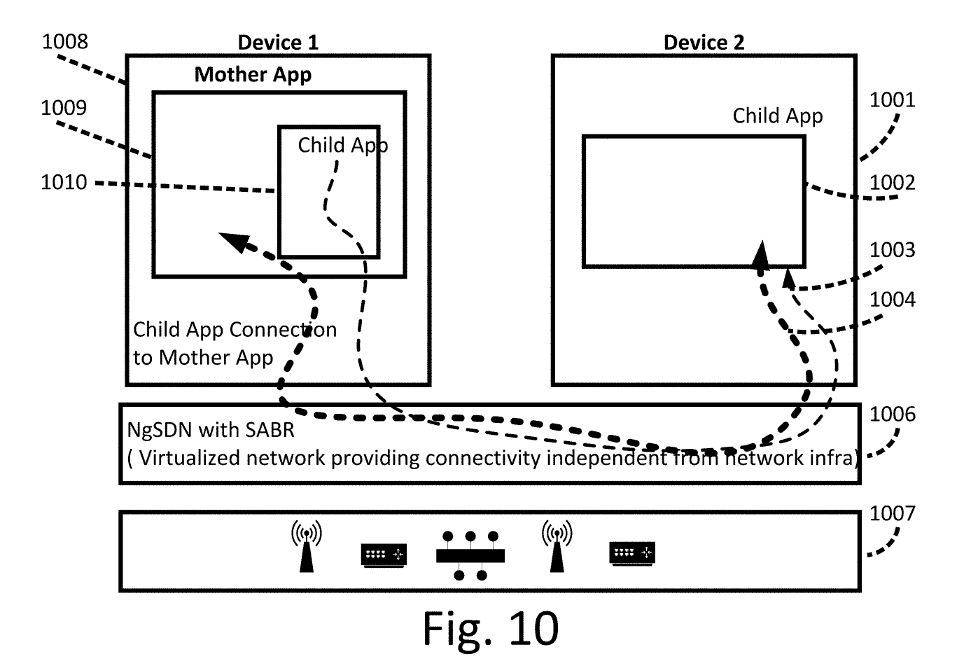

In FIG. 10, 1000 diagram presents the mother-child application structure and its related data traffic. 1001 illustrates the destination device hosting the child application from the mother application on the source device of 1008. 1002 is the child application generated from the mother application 1009. Child application maintains connectivity through data traffic shown as 1004. 1008 illustrates the child application hosted in mother application 1009 and the child application can be transferred to other device via traffic path 1003. 1006 is the means of connectivity between 2 devices which could be based on NgSDN or any other means for connectivity. 1007 illustrates the L1 and L2 means of connectivity between devices which is transparent to mother and child application.

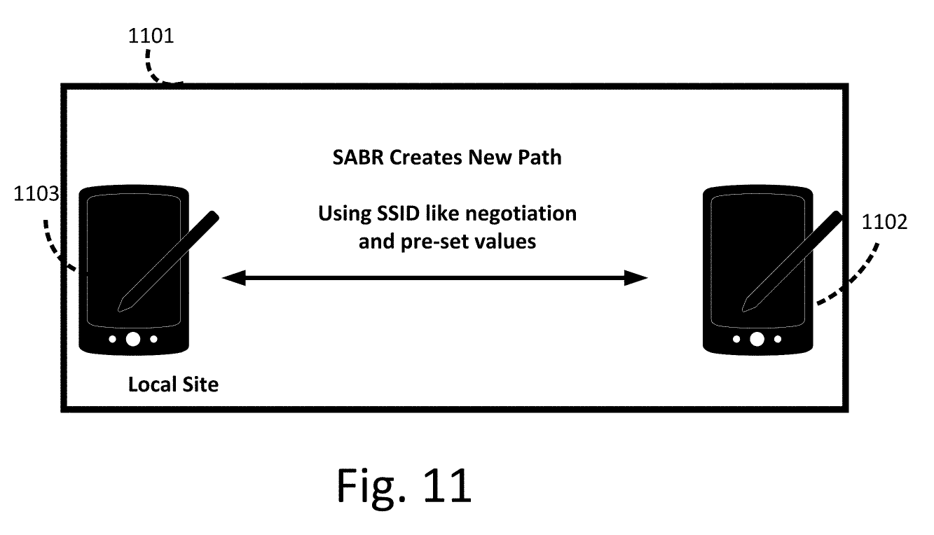

In FIG. 11, 1100 diagram illustrates how 2 devices can create a direct connection with each other without assistance of a common point of contact. 1101 illustrates both devices are connected to the same network or they are in wireless reach of each other. 1101 and 1102 illustrates the 2 devices attempting to reach each other and are in the same proximity. The devices could use the routing-table they already exchange when they were connected to each other or they could enable their wireless access points with their pre-negotiated SSID, at the time of detection of each other's SSID they will use the pre-configured passwords to establish a connection with each other and start to exchange data.

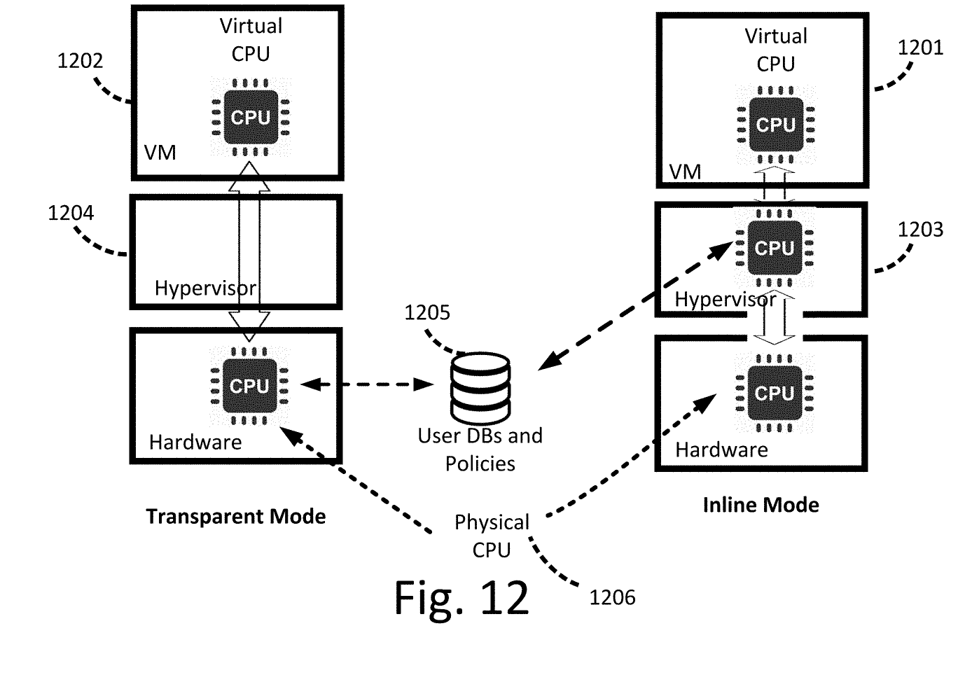

FIG. 12, 1200 diagram illustrates how CPU authentication and policies could be applied in transparent and line modes to a VM\Application\Container or Unikernel. 1201 and 1202 illustrate a VM\Application\Container or Unikernel that CPU resource been presented to using applied policies for the user. 1203 illustrates a hypervisor acting as an intermediary system to apply polices. CPU hardware 1206 been presented to the hypervisor 1203 and hypervisor assesses the applied rules and policies and presents the CPU resources to the VM\Container or Unikernel based on those policies. In transparent mode, the user's rules and policies 1205 are applied to the hardware able to process those policies and the resources would be directly presented to the VM\Application\Container or Unikernel without any interaction with hypervisor.

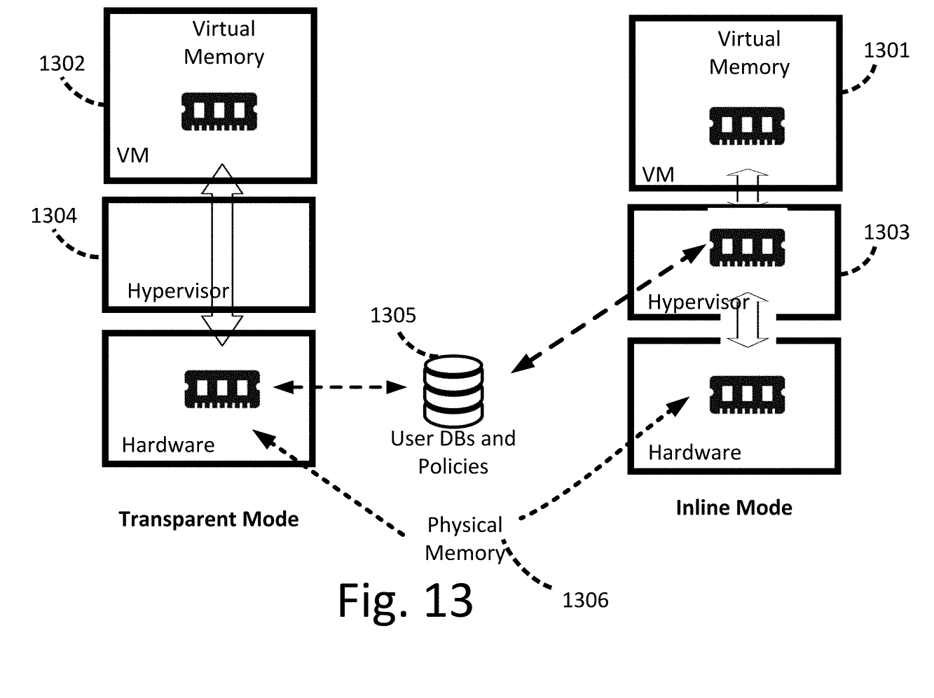

FIG. 13, 1300 diagram illustrates how Memory authentication and policies could be applied in transparent and line modes to a VM\Application\Container or Unikernel. 1301 and 1302 illustrate a VM\Application\Container or Unikernel that Memory resource been presented to using applied policies for the user. 1303 illustrates a hypervisor acting as an intermediary system to apply polices. Memory hardware 1306 been presented to the hypervisor 1303 and hypervisor assesses the applied rules and policies and presents the Memory resources to the VM\Container or Unikernel based on those policies. In transparent mode, the user's rules and policies 1305 are applied to the hardware able to process those policies and the resources would be directly presented to the VM\Application\Container or Unikernel without any interaction with hypervisor.

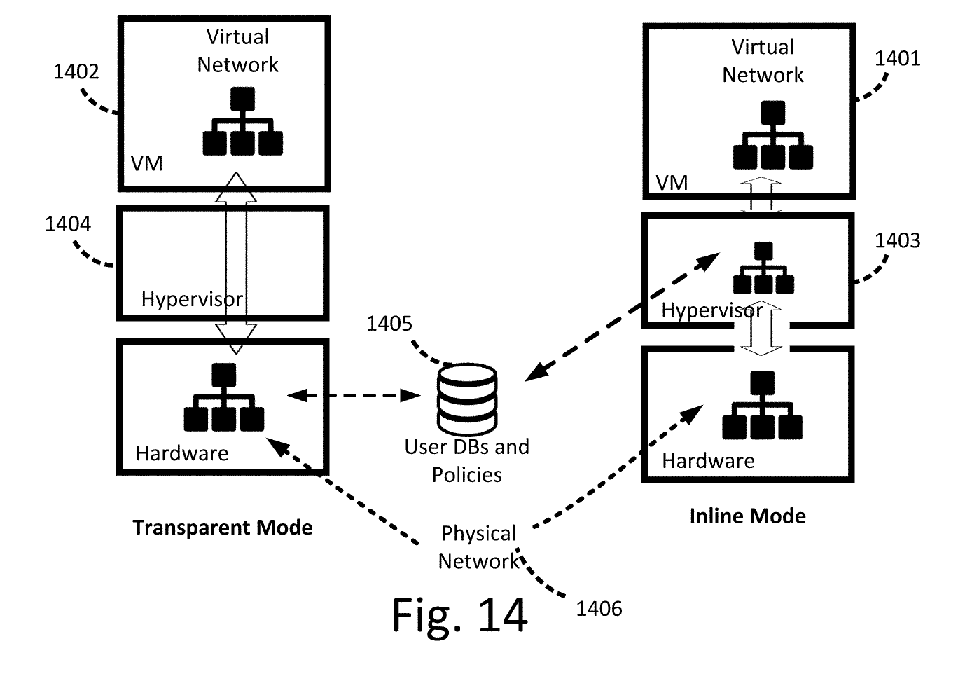

FIG. 14, 1400 diagram illustrates how Network authentication and policies could be applied in transparent and line modes to a VM\Application\Container or Unikernel. 1401 and 1402 illustrate a VM\Application\Container or Unikernel that Network resource been presented to using applied policies for the user. 1403 illustrates a hypervisor acting as an intermediary system to apply polices. Network hardware 1406 been presented to the hypervisor 1403 and hypervisor assesses the applied rules and policies and presents the Network resources to the VM\Container or Unikernel based on those policies. In transparent mode, the user's rules and policies 1405 are applied to the hardware able to process those policies and the resources would be directly presented to the VM\ApplicationTontainer or Unikernel without any interaction with hypervisor.

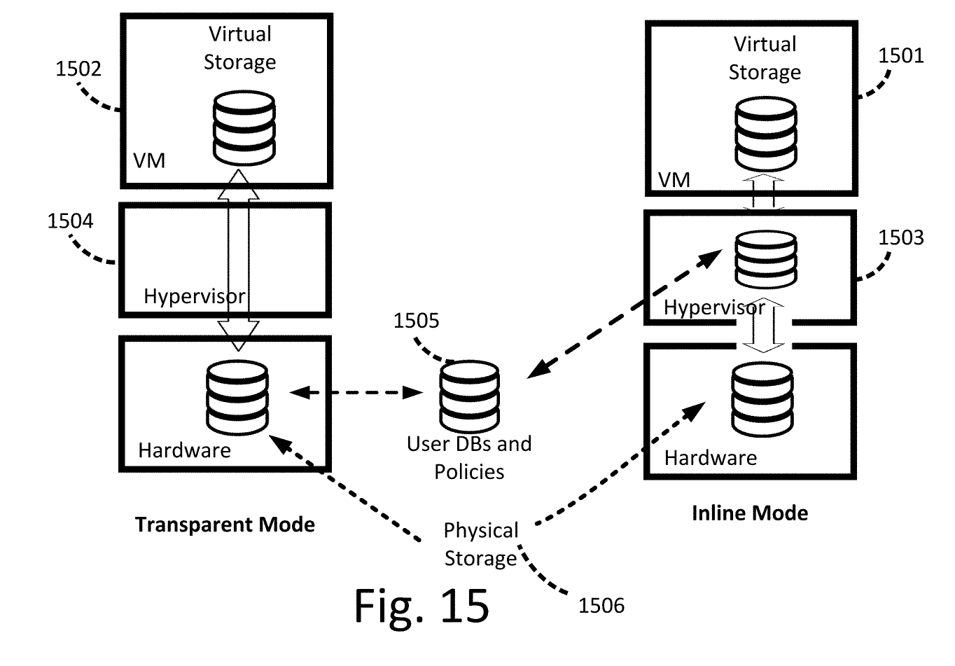

FIG. 15, 1500 diagram illustrates how Storage authentication and policies could be applied in transparent and line modes to a VM\Application\Container or Unikernel. 1501 and 1502 illustrate a VM\Application\Container or Unikernel that Storage resource been presented to using applied policies for the user. 1503 illustrates a hypervisor acting as an intermediary system to apply polices. Storage hardware 1506 been presented to the hypervisor 1503 and hypervisor assesses the applied rules and policies and presents the Storage resources to the VM\Container or Unikernel based on those policies. In transparent mode, the user's rules and policies 1505 are applied to the hardware able to process those policies and the resources would be directly presented to the VM\Application\Container or Unikernel without any interaction with hypervisor.

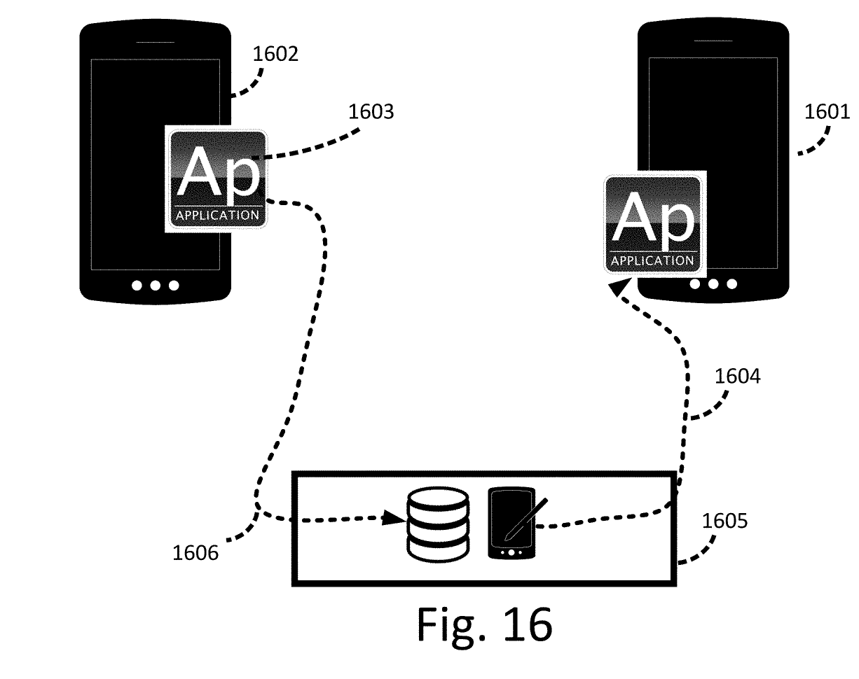

FIG. 16, 1600 diagram illustrates how application teleportation could be performed using token transfer. 1602 illustrates the source device hosting the running application 1603. 1601 illustrates the destination computing device acting as the receiver of the application using the token transfer method. 1605 illustrates any storage or portable device used to carry the token from source device to destination device. 1606 illustrates the application token created by the source device which could contain the application and its dependencies' data or Meta data and been transferred to a portable device. 1604 illustrates the token been transferred to the destination device for the application to be reconstructed and be migrated on the destination device.

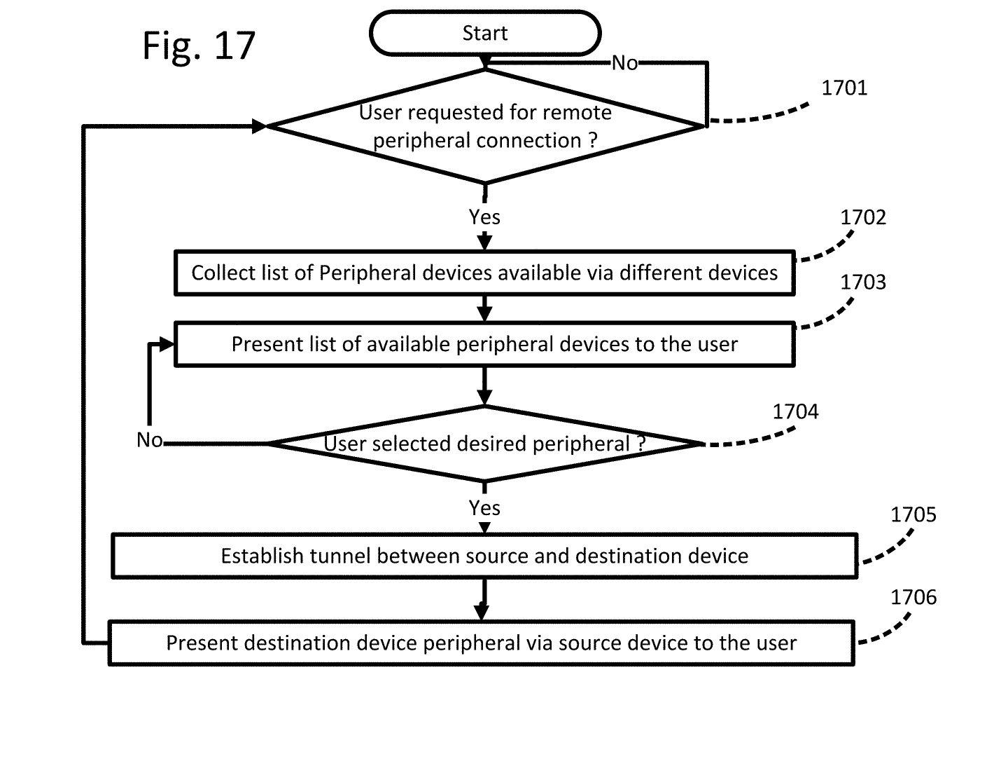

FIG. 17, 1700 flowchart illustrates the processes related to enabling peripheral connected to one device to the other Smart Universal Peripheral connection. 1701 illustrates system is waiting for user input to request a remote peripheral to be connected. 1702 tries to collect list of peripheral devices available on all devices user is authorized to access. 1703 list of all available peripherals across all devices been presented to the user and 1704 waits for the user to select the desired Peripherals to be connected. 1705 shows a tunnel been created between the device peripheral will be connected to and the device hosting the peripheral devices. 1706 uses this already tunnel established to present the peripheral from the source device to the destination device.

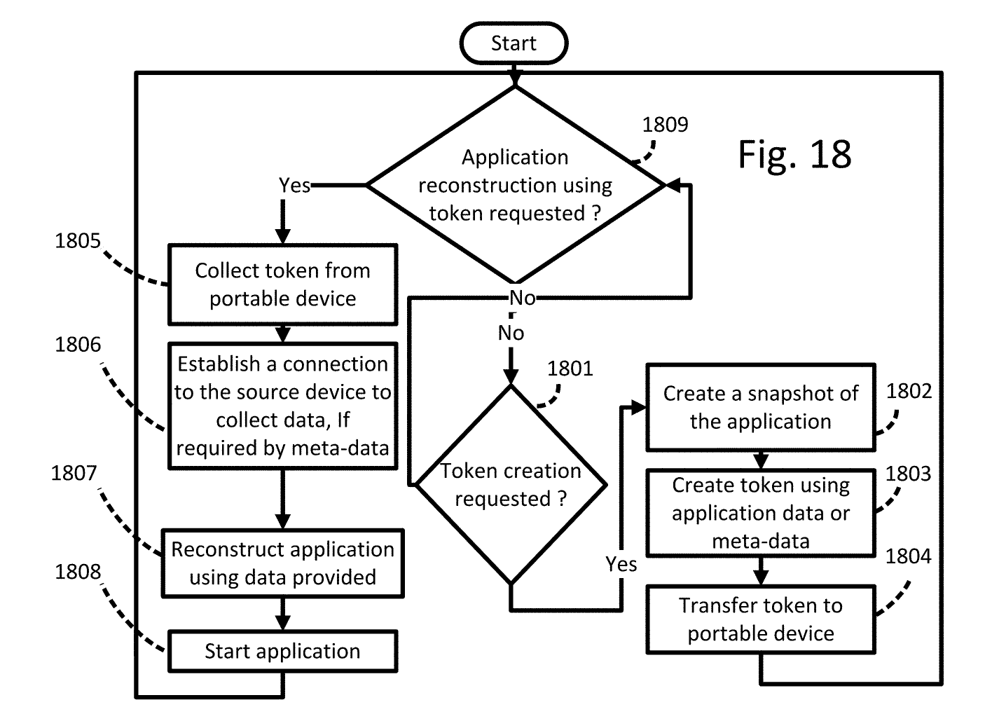

FIG. 18, 1800 flowchart illustrates the process of application transfer using token. 1801 illustrates the process application token creation. 1802 creates a snapshot on the application\VM\Container or Unikernel and the related data and meta-data are processed in 1803. 1804 illustrates the meta-data or the application data are getting transferred to a portable device. 1809 illustrates the process of application been reconstructed from the token already created. Token's been collected from the portable device or storage at 1805. 1806 shows based on the meta data a connection to the source device might be required to collect the application data, if connection is not required this step would pass with no connection. At 1807 application will be reconstructed using the data provided by the token to data collected from source device. 1808 shows application will be started on the destination device.

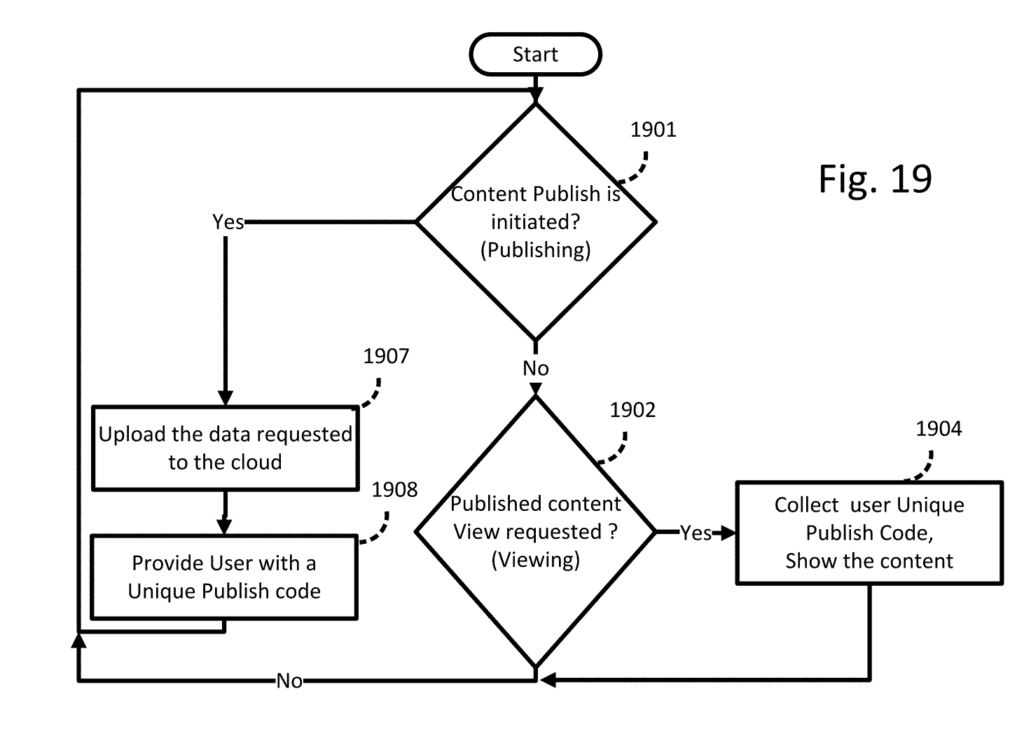

FIG. 19, 1900 illustrates the flowchart related to the process of Universal publish feature. 1901 illustrates when user attempts to make a file remote available to remote users or devices. 1907 shows the process of file been collected from the user and upload to the cloud to become accessible to remote users. A unique code been associated with the uploaded data and the code been provided to the user. 1902 illustrates the process of making the uploaded file available to remote user or devices. 1904 illustrates the collection of unique code from the user and presentation of the data related to that code to the user.

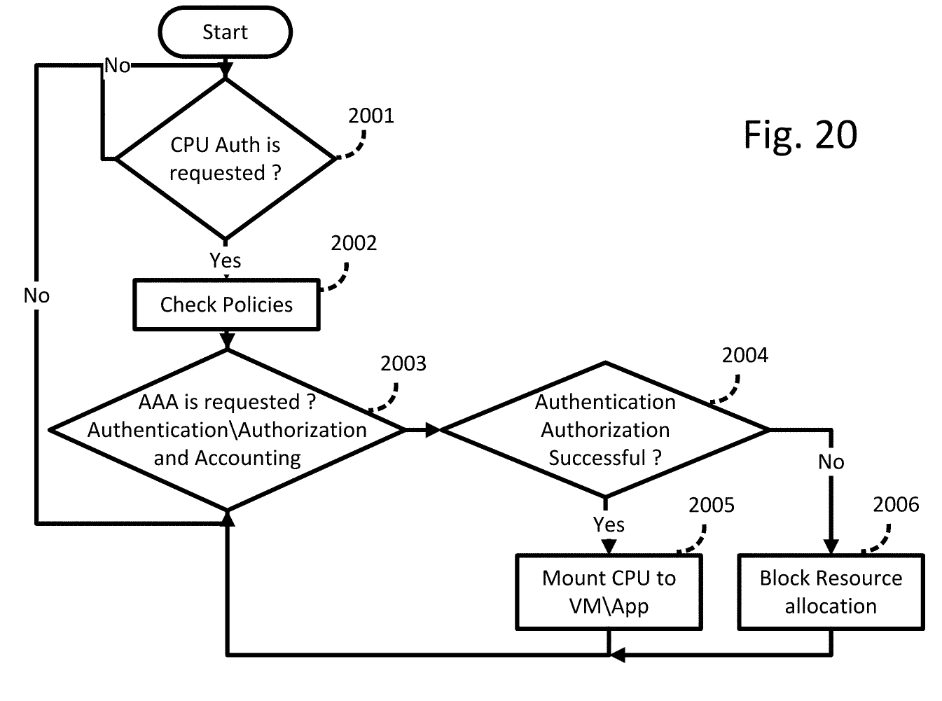

FIG. 20, 2000 illustrates the flowchart related to the process of CPU authentication feature. At 2002 shows CPU authentication been collected as it's been requested by a process in 2001. 2003 checks if AAA (Authentication, Authorization, Accounting) been requested by the user polices in 2002. Based on the collected policies at 2002 the user will be authentication against an identity server at 2004, if authentication is successful the resources are made available to user in 2005, if authentication fails resource allocation will be blocked as shown in 2006.

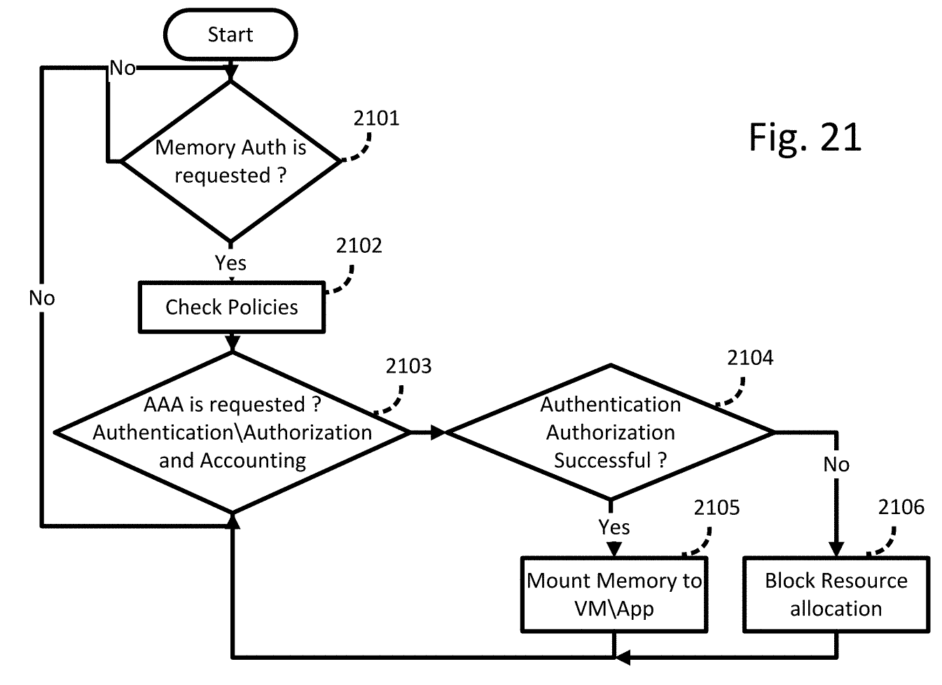

FIG. 21, 2100 illustrates the flowchart related to the process of Memory authentication feature. At 2102 shows Memory authentication been collected as it's been requested by a process in 2101. 2103 checks if AAA (Authentication, Authorization, Accounting) been requested by the user polices in 2102. Based on the collected policies at 2102 the user will be authentication against an identity server at 2104, if authentication is successful the resources are made available to user in 2105, if authentication fails resource allocation will be blocked as shown in 2106.

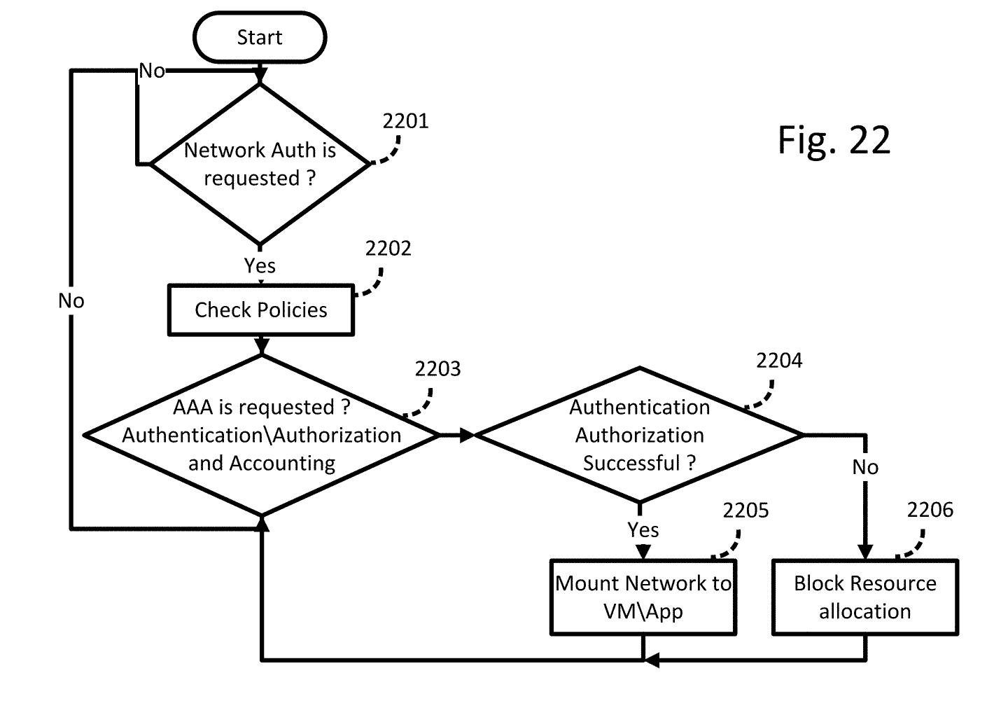

FIG. 22, 2200 illustrates the flowchart related to the process of Network authentication feature. At 2202 shows Network authentication been collected as it's been requested by a process in 2201. 2203 checks if AAA (Authentication, Authorization, Accounting) been requested by the user polices in 2202. Based on the collected policies at 2202 the user will be authentication against an identity server at 2204, if authentication is successful the resources are made available to user in 2205, if authentication fails resource allocation will be blocked as shown in 2206.

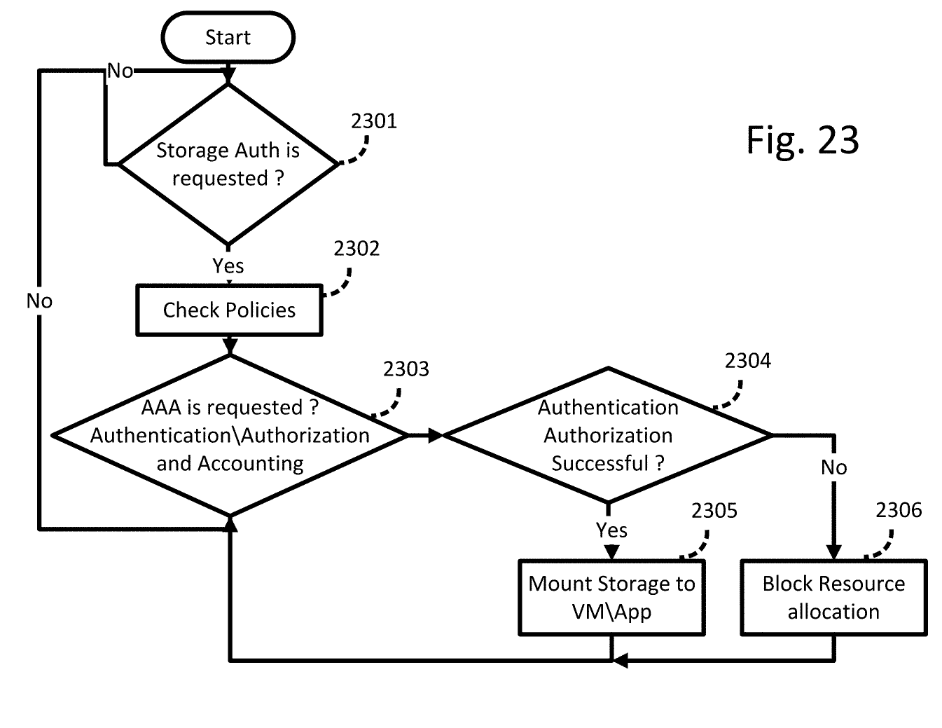

FIG. 23, 2300 illustrates the flowchart related to the process of Storage authentication feature. At 2302 shows Storage authentication been collected as it's been requested by a process in 2301. 2303 checks if AAA (Authentication, Authorization, Accounting) been requested by the user polices in 2302. Based on the collected policies at 2302 the user will be authentication against an identity server at 2304, if authentication is successful the resources are made available to user in 2305, if authentication fails resource allocation will be blocked as shown in 2306.

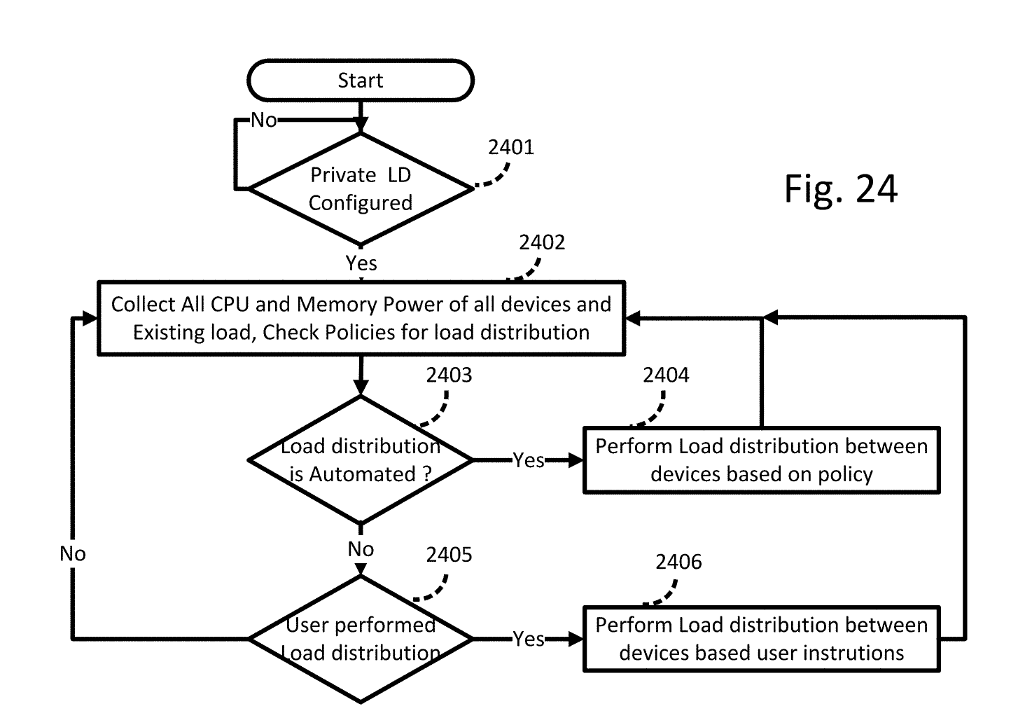

FIG. 24, 2400 illustrates the flowchart related to the process of Load distribution in a Private Resource pool. 2401 detects the policy set to use Private resource pool or not, if it's been configured, the system would collect information related to the resources available from all devices at 2402. At 2403 the automation of load distribution been detected, if automation has been configured depending on the set policies the application work load been distributed to the available resources at 2404. If automated load distribution not been configured 2403 process continues to 2405. 2405 detects if a manual load distribution been configured, if configuration been detected the process goes to 2406 and uses user configured load distribution configuration.

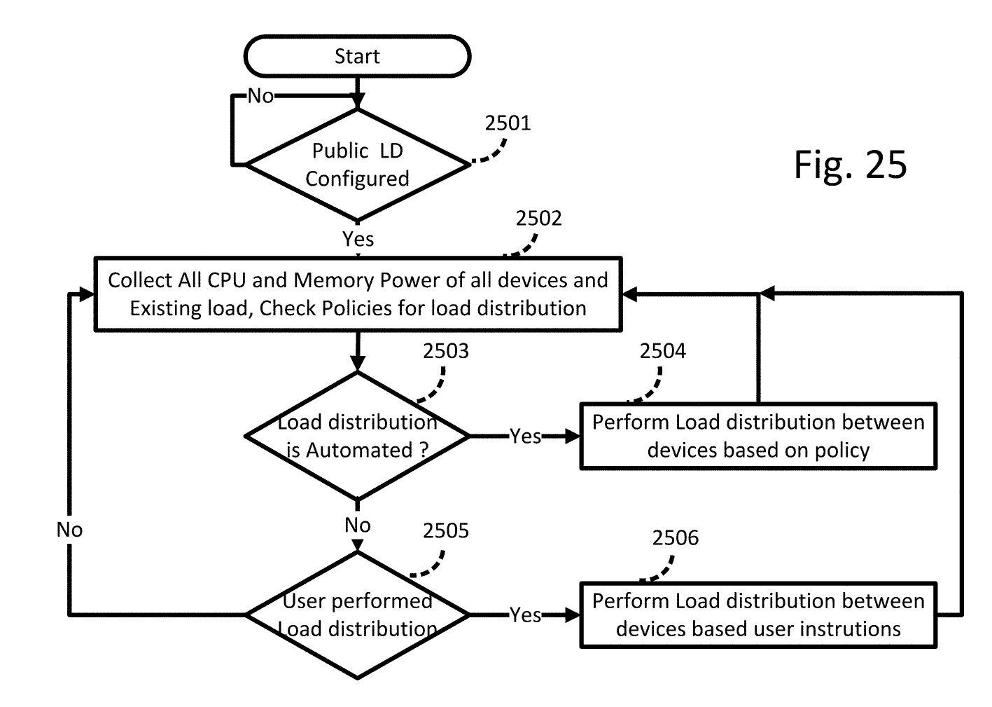

FIG. 25, 2500 illustrates the flowchart related to the process of Load distribution in a Public Resource pool. 2501 detects the policy set to use Public resource pool or not, if it's been configured, the system would collect information related to the resources available from all devices at 2502. At 2503 the automation of load distribution been detected, if automation has been configured depending on the set policies the application work load been distributed to the available resources at 2504. If automated load distribution not been configured 2503 process continues to 2505. 2505 detects if a manual load distribution been configured, if configuration been detected the process goes to 2506 and uses user configured load distribution configuration.

Any variation of the above teachings is also intended to be covered by the present application.

1. A method of transferring a running computer software application from a first device to a second device, said method comprising transfer of face, brain and body of the computer software application from said first device to said second device, wherein face is the computer software application display that users interact with, brain is the active part of the computer software application and body is the part of computer software application that holds the main portion of data and files for the computer software application to run.

2. A method of improving availability and accessibility of computer software applications, said method comprising teleporting a running computer software application from a first computer at a first location to a wearable device worn by a human, said human traveling to a second destination, and teleporting said running computer software application to a second computer.
